(19) United States
(12) Patent Application Publication
(10) Pub. No.: US 2011/0157254 A1
(43) Pub. Date: Jun. 30, 2011

(54) LIQUID CRYSTAL DISPLAY DEVICE AND ELECTRONIC DEVICE

(75) Inventors: Shunpei Yamazaki, Tokyo (JP); Jun Koyama, Sagamihara (JP); Yoshiharu Hirakata, Ebina (JP)

(73) Assignee: SEMICONDUCTOR ENERGY LABORATORY CO., LTD., Atsugi-shi (JP)

(21) Appl. No.: 12/978,798

(22) Filed: Dec. 27, 2010

(30) Foreign Application Priority Data
Dec. 28, 2009 (JP) 2009-298700

(51) Int. Cl. G09G 3/36; G09G 5/10; G02F 1/1335

(52) U.S. Cl. 345/690; 349/113; 345/102

(57) ABSTRACT

It is an object to provide a liquid crystal display device which can recognize image display even in the dim surrounding environment of the liquid crystal display device. It is another object to provide a liquid crystal display device which can perform image display in both modes: a reflective mode in which external light is used as an illumination light source; and a transmissive mode in which a backlight is used. A plurality pairs of a pixel in which incident light through a liquid crystal layer is reflected and a light-transmitting pixel are provided; therefore, display image can be performed in both modes: the reflective mode in which external light is used as an illumination light source; and the transmissive mode in which a backlight is used. Further, each reflective pixel and light-transmitting pixel may be connected to an independent signal driver circuit.

### TECHNICAL FIELD

The present invention relates to a semiconductor device having a circuit formed using a thin film transistor (hereinafter referred to as a TFT) and a manufacturing method thereof. For example, the present invention relates to an electronic device on which an electro-optical device typified by a liquid crystal display panel is mounted as a component.

In this specification, a semiconductor device generally means all types of devices which can function by utilizing semiconductor characteristics, and an electro-optical device, a semiconductor circuit, and an electronic device are all semiconductor devices.

### BACKGROUND ART

In a liquid crystal display device, an active matrix liquid crystal display device, in which pixel electrodes are provided in matrix and a transistor is used as a switching element connected to each pixel electrode in order to obtain an image with high quality, has attracted attention.

An active matrix liquid crystal display device, in which a transistor formed using a metal oxide for a channel formation region is used as a switching element connected to each pixel electrode, has already been known (see Patent Document 1 and Patent Document 2).

It is known that an active matrix liquid crystal display device is classified into two major types: transmissive type and reflective type.

In the transmissive liquid crystal display device, a backlight such as a cold cathode fluorescent lamp or the like is used and an optical modulation operation is utilized to choose between the two state: a state in which light from the backlight passes through liquid crystal to be output to the outside of the liquid crystal display device and a state in which light is not output, whereby bright and dark images are displayed; further, image display is performed in combination of them.

Since a backlight is utilized in the transmissive liquid crystal display device, it is difficult to recognize display in the environment with strong external light, for example, outdoors.

In the reflective liquid crystal display device, the optical modulation operation of liquid crystal is utilized to choose between the two states: a state in which external light, that is, incident light reflects on a pixel electrode to be output to the outside of the device and a state in which incident light is not output to the outside of the device, whereby bright and dark images are displayed; further, image display is performed in combination of them.

Compared to the transmissive liquid crystal display device, the reflective liquid crystal display device has an advantage of low power consumption since a backlight is not used; therefore, a demand for the reflective liquid crystal display device as a portable information terminal has been increasing.

Since external light is utilized in the reflective liquid crystal display device, the reflective liquid crystal display device is suited to image display in the environment with strong external light, for example, outdoors. On the other hand, it is difficult to recognize display in the dim surrounding environment of the liquid crystal display device, that is, in the environment with weak external light.

### REFERENCE

[Patent Document 1] Japanese Published Patent Application No. 2007-123861
[Patent Document 2] Japanese Published Patent Application No. 2007-96055

### DISCLOSURE OF INVENTION

It is an object to provide a liquid crystal display device which can recognize image display even in the dim surrounding environment of the liquid crystal display device.

It is another object to provide a liquid crystal display device which can perform image display in both modes: a reflective mode in which external light is used as an illumination light source; and a transmissive mode in which a backlight is used.

A plurality of pairs of a pixel in which incident light through a liquid crystal layer is reflected and a light-transmitting pixel are provided; therefore, display image can be performed in both modes: the reflective mode in which external light is used as an illumination light source; and the transmissive mode in which a backlight is used.

When there is external light with enough brightness, this liquid crystal display device is put in the reflective mode and a still image is displayed, whereby power consumption can be reduced.

When external light is weak or there is no external light, a backlight emits light in the transmissive mode, and image display can be performed.

A sensor for detecting brightness of the surroundings of the liquid crystal display device is preferably provided and on/off of the reflective mode, the transmissive mode, or a backlight is preferably performed in accordance with data obtained by using the sensor and the amount of light is preferably controlled in accordance with the data obtained by using the sensor.

For a light source of the backlight, it is preferable to use a plurality of light-emitting diodes (LEDs) in which power consumption can be further reduced as compared to a cold cathode fluorescent lamp and which can control the strength and weakness of light. The use of LEDs for the backlight partly controls the strength and weakness of light, whereby image display with high contrast and high color visibility can be performed.

An embodiment of the present invention disclosed in this specification comprises a display panel, a backlight portion, and an image processing circuit and the display panel includes a plurality of pairs of a first sub-pixel and a second sub-pixel. The first sub-pixel is connected to a scan line and a first signal line and includes a light-transmitting first pixel electrode and a transistor. The second sub-pixel is connected to a scan line and a second signal line and includes a second pixel electrode which reflect visible light and a transistor. The first pixel electrode and the second pixel electrode each control an orientation state of liquid crystal. The image processing circuit includes a memory circuit configured to store image signals, a comparison circuit configured to compare image signals in successive frame periods stored in the memory circuit and to calculate a difference, and a display control circuit. The liquid crystal display device has a moving-image display mode in which the comparison circuit determines that successive frame periods in which a difference is detected is a moving image period, the image processing circuit outputs a first signal including the moving image to the first signal line of the display panel, and the image processing circuit outputs a second signal to the backlight portion. Further, the image processing circuit has a still-image display mode in which the comparison circuit determines that successive frame periods in which a difference is not detected is a still image periods, the image processing circuit converts a still image in the still image period into a monochrome still image, the image processing circuit outputs the first signal including the monochrome still image to the second signal line of the display panel, and the image processing circuit stops the backlight portion.

Another embodiment of the present invention is the above-described liquid crystal display device including a photometric circuit, and being capable of operating in the moving-image display mode in accordance with a brightness of external light even when the comparison circuit determines that successive frame periods stored in the memory circuit is a still image period.

Another embodiment of the present invention is the above-described liquid crystal display device including a photometric circuit, and being capable of operating in the still-image display mode in accordance with a brightness of external light even when the comparison circuit determines that successive frame periods stored in the memory circuit is a moving image period.

Another embodiment of the present invention is the above-described liquid crystal display device in which the transistor includes a highly purified oxide semiconductor layer.

Another embodiment of the present invention is an electronic device including the above-described liquid crystal display device which includes a solar battery. The solar battery and the display panel are attached to be freely opened and closed, and electric power from the solar battery is supplied to the display panel, the backlight portion, or the image processing circuit.

Another embodiment of the present invention is a liquid crystal display device including: a plurality of structures over a substrate; a reflective layer covering side surfaces of the plurality of structures; an insulating layer covering the reflective layer; a pixel electrode including a reflective region overlapping with the reflective layer with the insulating layer provided therebetween, and a transmissive region overlapping with a top surface of each of the structure; and a transistor electrically connected to the pixel electrode.

Another embodiment of the present invention is a liquid crystal display device including two inclined planes facing each other at a cross section of the structures. An angle θT formed by an inclination of the inclined plane of the structure and an inclination of the inclined plane facing the inclined plane is less than 90°, preferably greater than or equal to 10° and less than or equal to 60°.

Another embodiment of the present invention is a liquid crystal display device characterized in that the reflective electrode of a reflective region includes a curving surface and an angle θR at point where the reflective electrode is most curved at the cross section of the reflective electrode, formed by two inclined planes facing each other is greater than of equal to 90°, preferably greater than or equal to 100° and less than or equal to 120°.

With the above structure, at least one of the above problems can be resolved.

A liquid crystal display device which can recognize an image displayed can be provided. It is possible to provide a liquid crystal display device which can perform image display in both modes: a reflective mode in which external light is used as an illumination light source; and a transmissive mode in which a backlight is used. A liquid crystal display device in which image display can be performed in accordance with an environment of various brightness levels of external light can be provided. Further, low power consumption can be realized in displaying of a still image.

### BRIEF DESCRIPTION OF DRAWINGS

In the accompanying drawings:

FIG. 1 is a block diagram illustrating a structure of a display device according to Embodiment;

FIG. 2 is a block diagram illustrating a structure of a pixel according to Embodiment;

FIGS. 3A to 3C are timing charts according to Embodiment;

FIG. 4 is a perspective view of a liquid crystal module according to Embodiment;

FIG. 5A is a top view of a pixel according to Embodiment and FIG. 5B is an equivalent circuit thereof;

FIG. 6 is a cross-sectional view of a pixel according to Embodiment;

FIG. 7 is a cross-sectional view of a pixel according to Embodiment;

FIG. 8 is a cross-sectional view of a pixel according to Embodiment;

FIG. 9 is a cross-sectional view of a pixel according to Embodiment;

FIGS. 10A to 10D are views illustrating one embodiment of a transistor applicable to a liquid crystal display device;

FIGS. 11A to 11E are views illustrating one embodiment of a method for manufacturing the transistor applicable to a liquid crystal display device;

FIGS. 12A and 12B illustrate an external view and a block diagram of an electronic device provided with a display device of the present invention;

FIG. 13 is a view illustrating a plane structure of a pixel according to Embodiment;

FIGS. 14A to 14E are views each illustrating a cross-sectional structure of a pixel according to Embodiment; and

FIG. 15 is a view illustrating a cross-sectional view of a pixel according to Embodiment.

### BEST MODE FOR CARRYING OUT THE INVENTION

Hereinafter, embodiments of the present invention will be described in detail with reference to the accompanying drawings. However, the present invention is not limited to the following description, and it is easily understood by those skilled in the art that modes and details disclosed herein can be modified in various ways. Therefore, the present invention is not construed as being limited to description of the embodiments below.

### Embodiment 1

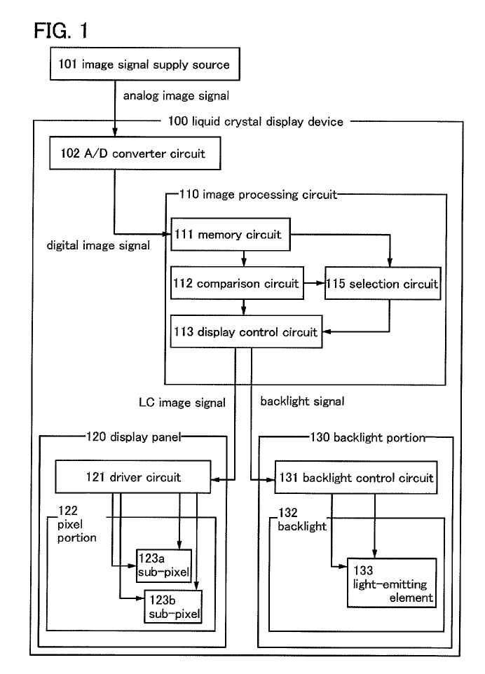

In this embodiment, a liquid crystal display device including a still-image mode and moving-image mode is described with reference to FIG. 1.

A display device 100 of this embodiment includes an A/D converter circuit 102, an image processing circuit 110, a display panel 120, and a backlight portion 130.

The image processing circuit 110 includes a memory circuit 111, a comparison circuit 112, a display control circuit 113, and a selection circuit 115.

The display panel 120 includes a driver circuit 121 and a pixel portion 122. The pixel portion 122 includes a first sub-pixel 123a connected to a first scan line and a first signal line and a second sub-pixel 123b connected to a second scan line and a second signal line. A plurality of pairs of the sub-pixel 123a and the sub-pixel 123b is arranged in matrix in the pixel portion 122.

The sub-pixel 123a includes a first transistor, a pixel electrode connected to the transistor, and a capacitor. A liquid crystal layer is sandwiched between the pixel electrode and a counter electrode facing the pixel electrode to form a liquid crystal element. The pixel electrode reflects incident light through the liquid crystal layer.

The sub-pixel 123b includes a second transistor, a pixel electrode connected to the transistor, and a capacitor. A liquid crystal layer is sandwiched between the pixel electrode and a counter electrode facing the pixel electrode to form a liquid crystal element. The pixel electrode has a light-transmitting property.

An example of liquid crystal elements is an element which controls transmission and non-transmission of light by the optical modulation of liquid crystals. The element can include a pair of electrodes and a liquid crystal layer. The optical modulation of liquid crystals is controlled by an electric field applied to the liquid crystals (that is, a vertical electric field). Note that specifically, the following can be used for a liquid crystal element, for example: a nematic liquid crystal, a cholesteric liquid crystal, a smectic liquid crystal, a discotic liquid crystal, a thermotropic liquid crystal, a lyotropic liquid crystal, a low-molecular liquid crystal, a high-molecular liquid crystal, a polymer dispersed liquid crystal (PDLC), a ferroelectric liquid crystal, an anti-ferroelectric liquid crystal, a main-chain liquid crystal, a side-chain high-molecular liquid crystal, a banana-shaped liquid crystal, and the like. In addition, the following can be used as a diving method of a liquid crystal, for example: a TN (twisted nematic) mode, an STN (super twisted nematic) mode, an OCB (optically compensated birefringence) mode, an ECB (electrically controlled birefringence) mode, an FLC (ferroelectric liquid crystal) mode, an AFLC (anti-ferroelectric liquid crystal) mode, a PDLC (polymer dispersed liquid crystal) mode, a PNLC (polymer network liquid crystal) mode, a guest-host mode, and the like.

The backlight portion 130 includes a backlight control circuit 131 and a backlight 132. The light emitted from the backlight 132 includes at least three primary colors. The backlight 132 includes a white light-emitting element 133, for example.

Next, a signal flow in the display device described in this embodiment is described.

An analog image signal is input to the display device 100 from an image signal supply source 101. The analog image signal includes an image signal such as signals each corresponding to red (R), green (G), and blue (B).

In the A/D converter circuit 102, the analog image signal is converted into a digital image signal and the digital image signal is output to the image processing circuit 110. When the image signal is converted into a digital signal in advance, detection of a difference of the image signal that is to be performed later can be easily performed, which is preferable.

The image processing circuit 110 generates an LC image signal and a backlight signal from the digital image signal which is input. The LC image signal controls the display panel 120. The backlight signal controls the backlight portion 130.

The memory circuit 111 provided in the image processing circuit 110 includes a plurality of frame memories for storing image signals of a plurality of frames. The number of frame memories included in the memory circuit 111 is not particularly limited as long as the image signals of a plurality of frames can be stored. Note that the frame memory may be formed using a memory element such as dynamic random access memory (DRAM) or static random access memory (SRAM).

The number of frame memories is not particularly limited as long as an image signal can be stored for each frame period. Further, the image signals stored in the frame memories are selectively read out by the comparison circuit 112 and the display control circuit 113.

The comparison circuit 112 is a circuit which selectively reads out image signals in successive frame periods stored in the memory circuit 111, compares the image signals in the series of frame periods in each pixel, and detects a difference thereof.

Whether or not a difference is detected determines the operation of the display control circuit 113 and the selection circuit 115. By the comparison between the image signals in the comparison circuit 112, when a difference is detected in any pixel, a series of frame periods during which the difference is detected is determined as a moving image period. On the other hand, by the comparison between the image signals in the comparison circuit 112, when differences are not detected in all the pixels, successive frame periods during which the difference is not detected is determined as a still image period. In other words, in the comparison circuit 112, by detection of the differences in the comparison circuit 112, the image signals in the series of frame periods are determined as image signals for displaying moving images or image signals for displaying still images.

Note that the difference obtained by the comparison may be set to be detected when the difference exceeds a certain level. The comparison circuit 112 may be set to determine detection of a difference by the absolute value of the difference regardless of the values of the differences.

Although, in this embodiment, the structure in which a moving image or a still image is determined by detection of the difference of the image signal in successive frame periods by the comparison circuit 112 is described, a structure in which a still image or a moving image is supplied by supplying a signal used for switching a still image or a moving image from the outside may be used.

Note that by switching of a plurality of images which is time-divided into a plurality of frames at high speed, the images are recognized as the moving image by human eyes. Specifically, by switching of images at least 60 times (60 frames) per second, the images are recognized as the moving image with less flicker by human eyes. In contrast, unlike a moving image or a partial moving image which includes a moving image and a still image in one frame, a still image is an image signal which does not change in successive frame periods, for example, in an n-th frame and an (n+1)th frame though a plurality of images which is time-divided into a plurality of frame periods is switched at high speed.

The selection circuit 115 includes a plurality of switches such as a switch formed using a transistor. When the difference is detected by calculation in the comparison circuit 112, that is, when an image displayed in the series of frames is a moving image, the selection circuit 115 is a circuit for selecting the image signals from the frame memories in the memory circuit 111 in which the image signal is stored, and for outputting the image signals to the display control circuit 113.

When the difference of the image signal is not detected by calculation in the comparison circuit 112, that is, when an image displayed in the series of frames is a still image, the selection circuit 115 does not output the image signals to the display control circuit 113. In the case of the still image, in the selection circuit 115, a structure may be employed in which an image signal is not output to the display control circuit 113 from the frame memory; and thus, power consumption can be reduced.

In the display device of this embodiment, a mode performed in such a way that the comparison circuit 112 determines the image signal as a still image is described as a still-image mode, and a mode performed in such a way that the comparison circuit 112 determines the image signal as a moving image is described as a moving-image mode.

The image processing circuit described in this embodiment may have a mode-switching function. The mode-switching function is a function of switching between a moving-image mode and a still-image mode in such a manner that a user of the display device selects an operation mode of the display device by hand or using an external connection device.

The selection circuit 115 can output the image signal to the display control circuit 113 in accordance with a signal input from the mode-switching circuit.

For example, in the case where a mode-switching signal is input to the selection circuit 115 from the mode-switching circuit while an operation is performed in a still-image display mode, even when the comparison circuit 112 does not detect the difference of the image signal in successive frame periods, the selection circuit 115 can be operated in a mode in which image signals which are input are sequentially output to the display control circuit 113, that is, in a moving-image display mode. In the case where a mode-switching signal is input to the selection circuit 115 from the mode-switching circuit while an operation is performed in a moving-image display mode, even when the comparison circuit 112 detects the difference of the image signal in successive frame periods, the selection circuit 115 can be operated in a mode in which only an image signal of one selected frame is output, that is, in a still-image display mode. As a result, in the display device of this embodiment, one frame among moving images is displayed as a still image.

The display control circuit 113 is a circuit used to supply the image signal selected by the selection circuit 115 in accordance with detection of the difference in the comparison circuit 112 and supply a signal for controlling the driver circuit 121 of the display panel 120 and the backlight control circuit 131 of the backlight portion 130.

Specifically, the display control circuit 113 supplies a signal for controlling switching between supplying and stopping of a control signal such as a start pulse SP and a clock signal CK to the display panel 120. The display control circuit 113 supplies a signal for controlling on/off of a backlight to the backlight control circuit 131.

The display device described in this embodiment includes the first sub-pixel 123a connected to the first signal line and the second sub-pixel 123b connected to the second signal line. The display control circuit 113 determines a signal line which outputs the image signal.

Specifically, when the comparison circuit 112 determines that the image signal is a still image, the display control circuit 113 outputs the image signal to the second sub-pixel 123b. When the comparison circuit 112 determines that the image signal is a moving image, the display control circuit 113 outputs the image signal to the first sub-pixel 123a.

When the comparison circuit 112 determines that the image signal is a moving image, the image signal is read out from the memory circuit 111 through the selection circuit 115, supplied to the driver circuit 121 by the display control circuit 113, and output to the first sub-pixel 123a. In addition, the display control circuit 113 supplies a control signal to the driver circuit 121.

The display device described in this embodiment may include a photometric circuit. The display device provided with the photometric circuit can detect the brightness of the environment where the display device is put. As a result, the display control circuit 113 connected to the photometric circuit can change a driving method of the display panel 120 in accordance with a signal input from the photometric circuit.

For example, when the photometric circuit detects the display device described in this embodiment which is used in a dim environment, the display control circuit 113 outputs the image signal to the first sub-pixel 123a and the backlight 132 is turned on even when the comparison circuit 112 determines that the image signal is a still image. Since the first pixel 123a includes the light-transmitting pixel electrode, a still image with high visibility can be provided using the backlight.

For example, when the photometric circuit detects the display device described in this embodiment which is used under extremely bright external light (e.g. under direct sunlight outdoors), the display control circuit 113 outputs the image signal to the second sub-pixel 123b even when the comparison circuit 112 determines that the image signal is a moving image. Since the second sub-pixel 123b includes a pixel electrode which reflects incident light through the liquid crystal layer, a still image with high visibility can be provided even under extremely bright external light.

In a period in which a still image is displayed using a structure of this embodiment, frequent writings of image signals can be eliminated. Further, there is a choice whether the backlight is used or not depending on the usage environment, which is convenient. In addition, power consumption is extremely low because a still image can be displayed without use of the backlight.

When an image to which an image signal is written plural times is seen, human eyes see images which switch plural times. Accordingly, such switching might cause eye strain. As described in this embodiment, the number of writings of image signals is reduced, whereby there is an effect of reducing eye strain.

This embodiment can be combined with any of the other embodiments in this specification, as appropriate.

### Embodiment 2

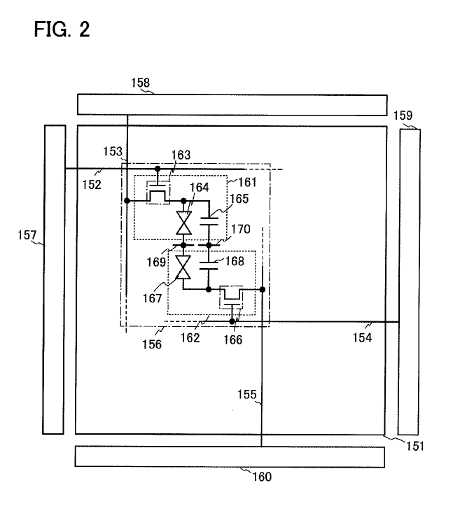

In this embodiment, a driving method of a liquid crystal display device will be described using a pixel connection diagram, a timing chart, and the like. First, FIG. 2 is a schematic view of a display panel of a liquid crystal display device. In FIG. 2, the display panel includes a pixel portion 151, a first scan line 152 (also referred to as a gate line), a first signal line 153 (also referred to as a data line), a second scan line 154, a second signal line 155, a pixel 156, a common electrode 169, a capacitor line 170, a first scan line driver circuit 157, a first signal line driver circuit 158, a second scan line driver circuit 159, and a second signal line driver circuit 160.

The pixel 156 is roughly classified into a light-transmitting electrode portion 161 and a reflective electrode portion 162. The light-transmitting electrode portion 161 includes a pixel transistor 163, a liquid crystal element 164, and a capacitor 165. A gate of the pixel transistor 163 is connected to the first scan line 152, a first terminal serving as one of a source and a drain of the pixel transistor 163 is connected to the first signal line 153, and a second terminal serving as the other of the source and the drain of the pixel transistor 163 is connected to one electrode of the liquid crystal element 164 and a first electrode of the capacitor 165. The other electrode of the liquid crystal element 164 is connected to the common electrode 169. A second electrode of the capacitor 165 is connected to the capacitor line 170.

The reflective electrode portion 162 includes a pixel transistor 166, a liquid crystal element 167, and a capacitor 168. A gate of the pixel transistor 166 is connected to the second scan line 154, a first terminal serving as one of a source and a drain of the pixel transistor 166 is connected to the second signal line 155, a second terminal serving as the other of the source and the drain of the pixel transistor 166 is connected to one electrode of the liquid crystal element 167 and a first electrode of the capacitor 168. The other electrode of the liquid crystal element 167 is connected to the common electrode 169. A second electrode of the capacitor 168 is connected to the capacitor line 170.

In FIG. 2, the first scan line 152 and the second scan line 154 are driven by the first scan line driver circuit 157 and the second scan line driver circuit 159, respectively. Respective image signals (hereinafter referred to as a first data and a second data) are supplied to the first signal line 153 and the second signal line 155 by the first signal line driver circuit 158 and the second signal line driver circuit 160, respectively. Grayscales based on different image signals are controlled in the liquid crystal element 164 of the light-transmitting electrode portion 161 and the liquid crystal element 167 of the reflective electrode portion 162.

The pixel transistor 163 and the pixel transistor 166 are preferably formed using thin film transistors (hereinafter also referred to as TFTs) having a thin oxide semiconductor layer.

Note that in this specification, a thin film transistor is an element having at least three terminals of gate, drain, and source and includes a channel region between a drain region and a source region, and current can flow through the drain region, the channel region, and the source region. Here, since the source and the drain of the transistor may change depending on the structure, the operating condition, and the like of the transistor, it is difficult to define which is a source or a drain. Therefore, in this document (the specification, the claims, the drawings, and the like), a region functioning as a source and a drain is not called the source or the drain in some cases. In such a case, for example, one of the source and the drain may be referred to as a first terminal and the other may be referred to as a second terminal. Alternatively, one of the source and the drain may be referred to as a first electrode and the other may be referred to as a second electrode. Further alternatively, one of the source and the drain may be referred to as a source region and the other thereof may be called a drain region.

The first scan line driver circuit 157, the first signal line driver circuit 158, the second scan line driver circuit 159, and the second signal line driver circuit 160 are preferably provided over the substrate over which the pixel portion 151 is formed; however, these are not necessarily formed over the same substrate. When the first scan line driver circuit 157, the first signal line driver circuit 158, the second scan line driver circuit 159, and the second signal line driver circuit 160 are provided over the substrate over which the pixel portion 151 is formed, the number of the connection terminals for connection to the outside and the size of the liquid crystal display device can be reduced.

Note that the pixels 156 are provided (arranged) in matrix. Here, description that pixels are provided (arranged) in matrix includes the case where the pixels are arranged in a straight line and the case where the pixels are arranged in a jagged line, in a longitudinal direction or a lateral direction. For example, in the case of performing full color display with three color elements (e.g., R (red), G (green), and B (blue)), the case where color filters are arranged in stripes and the case where dots of the three color elements are arranged in a delta pattern are included.

Note that when it is explicitly described that “A and B are connected,” the case where A and B are electrically connected, the case where A and B are functionally connected, and the case where A and B are directly connected are included therein.

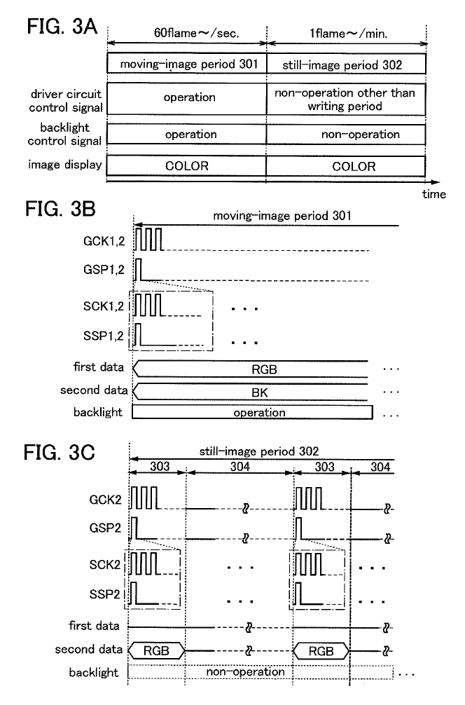

Next, the operation of the display panel together with the operation of the backlight will be described with reference to FIG. 3A. As described in the above embodiment, the operation of the display panel is classified roughly into a moving-image display period 301 and a still-image display period 302.

The cycle of one frame period (or frame frequency) is preferably less than or equal to 1/60 sec (more than or equal to 60 Hz) in the moving-image display period 301. The frame frequency is increased, so that flickering is not sensed by a viewer of an image. In the still-image display period 302, the cycle of one frame period is extremely long, for example, longer than or equal to one minute (less than or equal to 0.017 Hz), so that eye strain can be reduced compared to the case where the same image is switched plural times.

When an oxide semiconductor is used for a semiconductor layer of the pixel transistor 163 and the pixel transistor 166, an off-state current can be reduced because the number of carriers in the oxide semiconductor can be extremely small. Accordingly, an electrical signal such as an image signal can be held for a longer period in the pixel, and a writing interval can be set longer. Therefore, the cycle of one frame period can be set longer, and the frequency of refresh operations in the still-image display period 302 can be reduced, whereby an effect of suppressing power consumption can be further increased.

In the moving-image display period 301 illustrated in FIG. 3A, the image signal is distributed to each pixel, a driver circuit control signal for displaying a moving image is supplied to the first scan line driver circuit 157 and the first signal line driver circuit 158 (hereinafter referred to as a first driver circuit), and a driver circuit control signal for displaying a black grayscale (typically the lowest grayscale) on each pixel is supplied to the second scan line driver circuit 159 and the second signal line driver circuit 160 (hereinafter referred to as a second driver circuit), whereby the first driver circuit and the second driver circuit operate. In addition, in the moving-image display period 301 illustrated in FIG. 3A, a backlight of white light is operated by the backlight control signals. As an example, the display panel is configured to transmit light having a specific wavelength through color filters of R (red), G (green), and B (blue), whereby colored moving image can be performed.

As described in the above embodiment, in the still-image display period 302 illustrated in FIG. 3A, a driver circuit control signal for writing an image signal of a colored still image is supplied to the second driver circuit by transmission or non-transmission of reflected light, whereby the second driver circuit operates. When the first driver circuit is not operated and the driver circuit control circuit in a period other than the period of writing the image signal is not operated, power consumption can be reduced. In the still-image display period 302 illustrated in FIG. 3A, display comes to be visible utilizing reflected external light; therefore, the backlight is not operated by the backlight control signal. Then, the colored still image can be displayed on the display panel.

In the still-image display period 302, when a still image is displayed by transmission or non-transmission of reflected light, the still image may be displayed by monochrome grayscales in accordance with arrangement of color filters. In this case, the structure in which an image signal for displaying monochrome grayscales is supplied may be employed.

Next, the moving-image display period 301 and the still-image display period 302 of FIG. 3A will be described in details with reference to timing charts of FIG. 3B and FIG. 3C, respectively. The timing charts illustrated in FIG. 3B and FIG. 3C are exaggerated for description, and each signal does not operate in synchronization, except for the case where there is specific description.

First, FIG. 3B is described. FIG. 3B illustrates clock signals GCK (in the diagram, GCK1 and GCK2) which are supplied to the first scan line driver circuit 157 and the second scan line driver circuit 159, start pulses GSP (in the diagram, GSP1 and GSP2), clock signals SCK (in the diagram, SCK1 and SCK2) which are supplied to the first signal line driver circuit 158 and the second signal line driver circuit 160, start pulses SSP (in the diagram, SSP1 and SSP2), a first data, a second data, and a lighting state of the backlight in the moving-image display period 301 as an example. Low power consumption and life extension can be attempted by using a white LED as the backlight.

In the moving-image display period 301, each of the clock signals GCK1 and GCK2 becomes a clock signal which is always supplied. Each of the start pulses GSP1 and GSP2 becomes a pulse corresponding to vertical synchronization frequency. Each of the clock signals SCK1 and SCK2 becomes a clock signal which is always supplied. Each of the start pulses SSP1 and SSP2 becomes a pulse corresponding to one gate selection period. In the moving-image display period 301, the first data is written to the light-transmitting electrode portion 161 of the pixel 156 including pixels corresponding to respective colors of R (red), G (green), and B (blue), and transmission or non-transmission of light from the back light is controlled, so that a viewer can see color display of a moving image. In the moving-image display period 301, the second data is an image signal for displaying a black grayscale and is written to the reflective electrode portion 162 of the pixel 156. When the second data is used as an image signal for displaying a black grayscale (typically the lowest grayscale). Therefore, the visibility problem of a moving image of the light-transmitting electrode portion 161 such that the reflective electrode portion 162 reflects irradiated external light (light leakage) can be remedied.

Next, FIG. 3C will be described. In FIG. 3C, the still-image display period 302 is divided into a still-image writing period 303 and a still-image holding period 304 for description.

In the still-image writing period 303, the clock signal GCK2 supplied to the second scan line driver circuit 159 serves as a clock signal for writing to one screen. The start pulse GSP2 supplied to the second scan line driver circuit 159 serves as a pulse for writing to one screen. The clock signal SCK2 supplied to the second signal line driver circuit 160 serves as a clock signal for writing to one screen. The start pulse SSP2 supplied to the second signal line driver circuit 160 serves as a pulse for writing to one screen. Note that in the still-image writing period 303, a still image is displayed by the second data for color display utilizing reflected light; therefore, the backlight does not operate. Further, in the still-image writing period 303, low power consumption can be attempted when the first driver circuit and the first data are stopped.

In the still-image holding period 304, supply of the clock signals GCK1 and GCK2 for driving the first driver circuits and the second driver circuits, the start pulses GSP1 and GSP2, the clock signals SCK1 and SCK2, and the start pulses SSP1 and SSP2 are stopped. Therefore, in the still-image holding period 304, power consumption can be reduced and lower power consumption can be achieved. In the still-image holding period 304, the image signal written to the pixel in the still-image writing period 303 is held by the pixel transistor with extremely low off-state current; therefore, a colored still image can be held for longer than or equal to one minute. In the still-image holding period 304, before the amount of electric charges of the held image signal is decreased as a certain period passes, another still-image writing period 303 is provided, and an image signal which is the same as the image signal of the previous period is written (refresh operation), and the still-image holding period 304 may be provided again.

Note that in the still-image holding period 304, in order to achieve low power consumption, the backlight may be in a non-operating state.

In the liquid crystal display devices described in this embodiment, power consumption can be reduced when a still image is displayed.

This embodiment can be implemented in appropriate combination with the structures described in the other embodiments.

### Embodiment 3

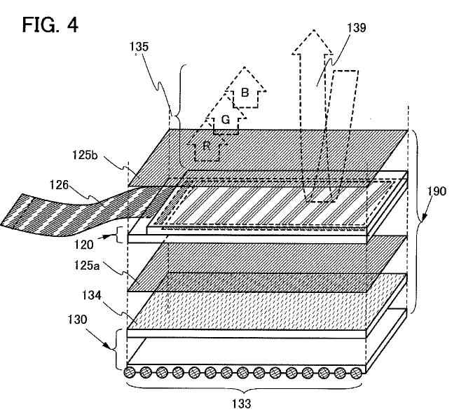

FIG. 4 illustrates a structure of a liquid crystal display module 190. The liquid crystal display module 190 includes a backlight portion 130, a display panel 120 in which liquid crystal elements arranged in matrix and a color filter overlapping with the liquid crystal elements are provided inside, and a polarizing plate 125a and a polarizing plate 125b with the display panel 120 positioned therebetween. The backlight portion 130 emits white light uniformly on the entire surface. For example, the backlight portion 130 may be a backlight portion including a white light-emitting element 133 (e.g., white LED) placed in an edge portion of a light guide plate and a diffusing plate 134 provided between the light guide plate and the display panel 120. In addition, a flexible printed circuit (FPC) 126 serving as an external input terminal is electrically connected to a terminal portion provided in the display panel 120.

In FIG. 4, three colors of light 135 are schematically denoted by arrows (R, G, and B). Light emitted from the backlight portion 130 is modulated by a liquid crystal element and the color filter of the display panel 120 and reaches a viewer through the liquid crystal display module 190, so that the viewer perceives an image.

Further, FIG. 4 schematically illustrates a state in which external light 139 is transmitted through the liquid crystal element in the display panel 120 and reflected by a bottom electrode below the liquid crystal element. The intensity of the light transmitted through the liquid crystal element is modulated by an image signal; therefore, a viewer can perceive an image also with reflection light of the external light 139.

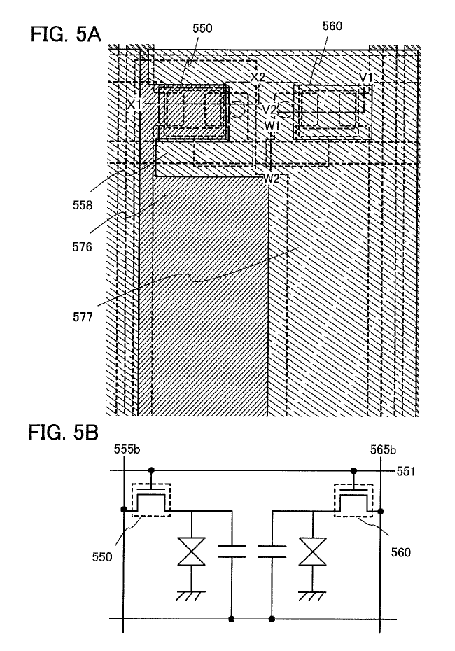

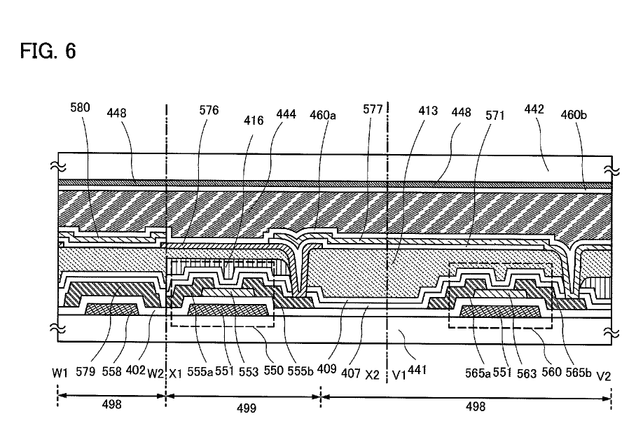

FIG. 5A is a plan view of a liquid crystal display device and FIG. 5B illustrates an equivalent circuit each illustrates one pixel thereof. FIG. 6 is a cross-sectional view taken along lines V1-V2, W1-W2, and X1-X2 of FIG. 5A.

In FIG. 5A, a plurality of source wirings 555b and 565b (including source or drain electrode layers) is arranged in parallel (extends upward and downward in the drawing) to be spaced from each other. A plurality of gate wiring layers (including a gate electrode layer 551) is provided to extend in a direction substantially perpendicular to the source wiring layers (the horizontal direction in the drawing) and spaced from each other. A capacitor wiring layer 558 is arranged adjacent to the plurality of gate wiring layers and extends in a direction generally parallel to the gate wiring layers, that is, in a direction generally perpendicular to the source wiring layers (in the horizontal direction in the drawing).

The liquid crystal display device in FIGS. 5A and 5B, and FIG. 6 is a semi-transmissive liquid crystal display device in which a pixel region is formed with a reflective region 498 and a transmissive region 499. Although the area ratio of the reflective region 498 to the transmissive region 499 may be set 1:1, for example, the area ratio of the reflective region 498 and the transmissive region 499 can be set by a designer as appropriate in accordance with the use application of the display device. In the reflective region 498, a reflective electrode layer 577 is formed as a pixel electrode layer, and in the transmissive region 499, the transparent electrode layer 576 is provided as a pixel electrode layer. As illustrated in FIGS. 5A and 5B and FIG. 6, when an end portion of the transparent electrode layer 576 and an end portion of the reflective electrode layer 577 are overlapped with each other with an insulating film 571 interposed therebetween, the display region can be effectively provided in the pixel region. Note that an example in which the transparent electrode layer 576, the insulating layer 571, and the reflective electrode layer 577 are stacked in that order over an interlayer film 413 is illustrated in FIG. 6; however, a structure in which the reflective electrode layer 577, the insulating layer 571, and the transparent electrode layer 576 are stacked in that order over the interlayer film 413 may be employed. In the transmissive region 499, a coloring layer 416 serving as a color filter layer is provided between a protective insulating layer 409 and the interlayer film 413.

As illustrated in an equivalent circuit of FIG. 5B, a transistor 560 which is electrically connected to the reflective electrode layer 577 and the source or drain electrode layer 565b and a transistor 550 which is electrically connected to the transparent electrode layer 576 and the source or drain electrode layer 555b are provided in one pixel. The transistor 560 is a transistor used for the reflective region which is used to control on/off of the reflective region. The transistor 550 is a transistor used for the transmissive region which is used to control on/off of the transmissive region.

As illustrated FIG. 6, insulating layers 407 and 409 and the interlayer film 413 are provided over the transistors 550 and 560. The transparent electrode layer 576 and the reflective electrode layer 577 are electrically connected to the transistors 550 and 560, respectively through openings (contact holes) provided in the insulating layers 407 and 409 and the interlayer film 413.

A common electrode layer 448 (also referred to as a counter electrode layer) is formed on a second substrate 442 and faces the transparent electrode layer 576 and the reflective electrode layer 577 over a first substrate 441 with a liquid crystal layer 444 provided therebetween. Note that in the liquid crystal display device in FIGS. 5A and 5B, and FIG. 6, an alignment film 460a is provided between the transparent electrode layer 576 and the liquid crystal layer 444 and between the reflective electrode layer 577 and the liquid crystal layer 444, an alignment film 460b is provided between the common electrode layer 448 and the liquid crystal layer 444. The alignment films 460a and 460b are insulating layers having a function of controlling alignment of liquid crystal and therefore, are not necessarily provided depending on a material of the liquid crystal.

The transistors 550 and 560 are examples of a bottom-gate inverted-staggered transistor. The transistor 550 includes the gate electrode layer 551, a gate insulating layer 402, a semiconductor layer 553, a source or drain electrode layer 555a, and the source or drain electrode layer 555b. The transistor 560 includes the gate electrode layer 551, the gate insulating layer 402, a semiconductor layer 563, a source or drain electrode layer 565a, and the source or drain electrode layer 565b. In addition, the transistors 550 and 560 each include a capacitor. As illustrated in FIG. 6, a capacitor wiring layer 558 which is formed in the same step as the gate electrode layer 551, the gate insulating layer 402, and a conductive layer 579 which is formed in the same step as the source or drain electrode layers 555a and 555b, and the source or drain electrode layers 565a and 565b are stacked to form a capacitor. Note that it is preferable to form a wiring layer 580 in the same step as the reflective electrode layer 577 which is formed using a reflective conductive film such as aluminum (Al), silver (Ag) to overlap with the capacitor wiring layer 558.

The semi-transmissive liquid crystal display device in this embodiment performs color display of moving images in the transmissive region 499 by control of turning on or off the transistor 550 and monochrome (black and white) display of still images in the reflective region 498 by control of turning on or off the transistor 560. The transistors 550 and 560 are operated separately, whereby each display in the reflective region 498 and in the transmissive region 499 can be controlled independently.

In the transmissive region 499, image display is performed by incident light from a backlight provided on the first substrate 441 side and passed through the second substrate 442 side. When a coloring layer serving as a color filter is provided in the liquid crystal display device, light from the backlight is transmitted through the coloring layer, whereby color display can be performed in the transmissive region. For example, in the case of performing full-color display, the color filter may be formed using a material showing red (R), green (G), or blue (B), or may be formed using another material showing yellow, cyan, magenta, or the like.

In FIG. 6, the coloring layer 416 serving as a color filter is provided between the protective insulating layer 409 and the interlayer film 413. Since the coloring layer 416 serves as a color filter, a light-transmitting resin layer which is formed using a material which transmits only chromatic color light may be used. An optimal thickness of the coloring layer 416 may be adjusted as appropriate in consideration of relation between the concentration of a coloring material included and the transmissivity of light. In the case where the thickness of the light-transmitting chromatic color resin layer varies depending on the chromatic colors or in the case where there is surface unevenness due to a transistor, an insulating layer which transmits light in a visible wavelength range (a so-called colorless, transparent insulating layer) may be formed for planarization of the surface of the interlayer film.

In the case where the coloring layer 416 is directly formed over the first substrate 441, the formation region can be controlled more precisely and this structure can be adjustable to a pixel with a minute pattern. Alternatively, the coloring layer 416 can be used as an interlayer film.

The coloring layer 416 may be formed using a photosensitive or non-photosensitive organic resin by a coating method.

On the other hand, in the reflective region 498, white display is performed by reflecting incident external light on the second substrate 442 side by the reflective electrode layer 577.

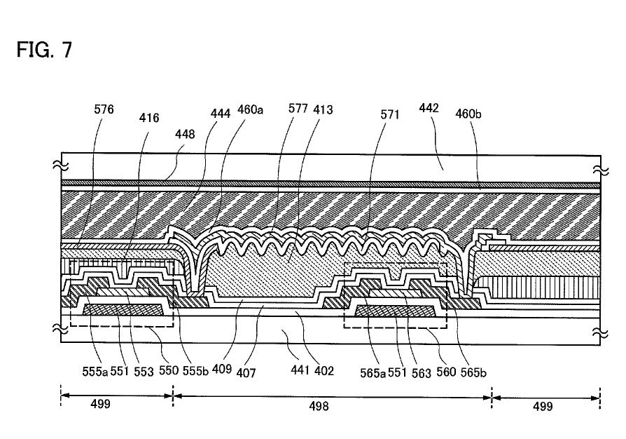

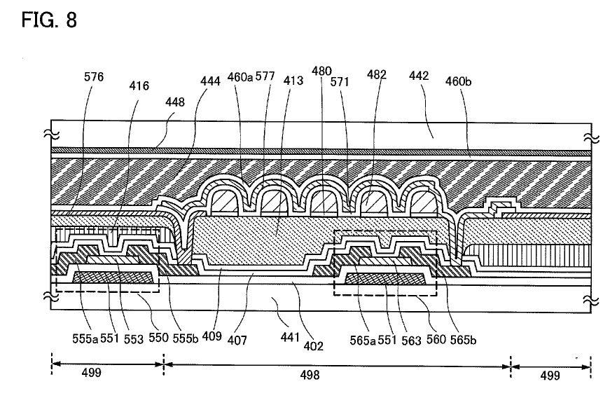

Examples in which the reflective electrode layer 577 is formed to have uneven shape in the liquid crystal display device are illustrated in FIG. 7 and FIG. 8. FIG. 7 illustrates an example in which a surface of the interlayer film 413 in the reflective region 498 is formed to have an uneven shape so that the reflective electrode layer 577 has unevenness. The uneven shape of the surface of the interlayer film 413 may be formed by performing selective etching. The interlayer film 413 having the uneven shape can be formed, for example, by performing a photolithography step on a photosensitive organic resin. FIG. 8 illustrates an example in which projected structures are provided over the interlayer film 413 in the reflective region 498 so that the reflective electrode layer 577 has an uneven shape. Note that in FIG. 8, the projected structures are formed by stacking an insulating layer 480 and an insulating layer 482. For example, an inorganic insulating layer of silicon oxide, silicon nitride, or the like can be used as the insulating layer 480, and an organic resin such as a polyimide resin or an acrylic resin can be used for the insulating layer 482. First, a silicon oxide film is formed over the interlayer film 413 by a sputtering method, and a polyimide resin film is formed over the silicon oxide film by a coating method. The polyimide resin film is etched with the use of the silicon oxide film as an etching stopper. The silicon oxide film is etched with the use of the etched polyimide resin layer as a mask, so that the projected structures formed from a stack of the insulating layer 480 and the insulating layer 482 can be formed as illustrated in FIG. 8.

As illustrated in FIG. 7 and FIG. 8, when the surface of the reflective electrode layer 577 has unevenness, incident external light is irregularly reflected, so that more favorable white display can be performed. Accordingly, visibility of white display is improved.

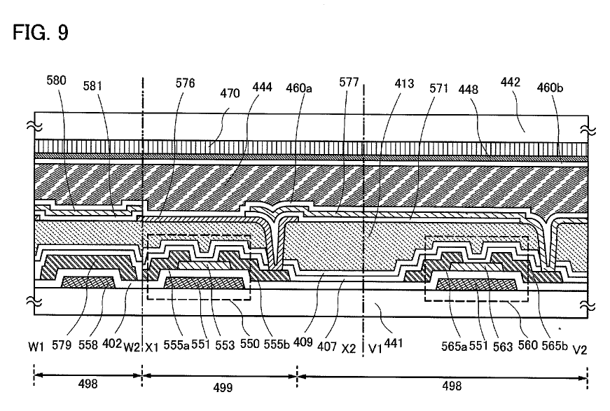

Although FIG. 6, FIG. 7, and FIG. 8 each illustrate an example in which monochrome display is performed in the reflective region 498, color display can also be performed in the reflective region 498. FIG. 9 illustrates an example in which full-color display is performed in both the transmissive region 499 and the reflective region 498.

In FIG. 9, a color filter 470 is provided between the second substrate 442 and the common electrode layer 448. By providing the color filter 470 between the reflective electrode layer 577 and the second substrate 442 on a viewer side, light reflected by the reflective electrode layer 577 is transmitted through the color filter 470, so that color display can be performed.

The color filter may be provided on the outer side of the second substrate 442 (on an opposite side to the liquid crystal layer 444).

Note that also in FIG. 7 and FIG. 8, if the color filter 470 is provided as illustrated in FIG. 9 instead of the coloring layer 416, full-color display can also be performed in the reflective region 498.

This embodiment can be freely combined with Embodiment 1 or 2.

### Embodiment 4

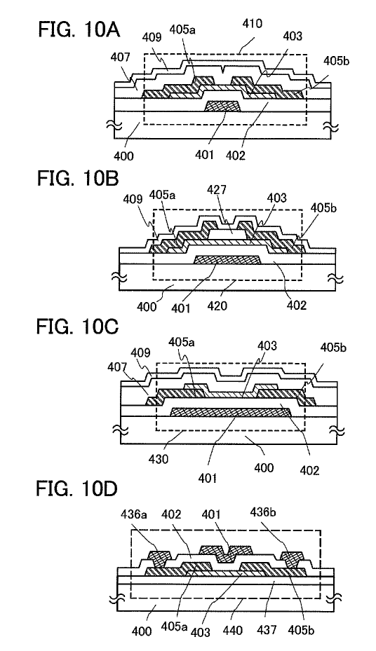

In this embodiment, an example of a transistor which can be applied to a liquid crystal display device disclosed in this specification is described. There is no particular limitation on a structure of a transistor which can be applied to a liquid crystal display device disclosed in this specification. For example, a top-gate structure or a bottom-gate structure such as a staggered type and a planar type can be used. The transistor may have a single-gate structure in which one channel formation region is formed, a double-gate structure in which two channel formation regions are formed, or a triple-gate structure in which three channel formation regions are formed. Alternatively, the transistor may have a dual-gate structure including two gate electrode layers positioned above and below a channel region with a gate insulating layer interposed therebetween. FIGS. 10A to 10D each illustrate an example of a cross-sectional structure of a transistor. Transistors illustrated in FIGS. 10A to 10D are transistors using an oxide semiconductor as a semiconductor. An advantage of using an oxide semiconductor is that high mobility and low off-state current can be obtained in a relatively easy and low-temperature process: however, it is needless to say that another semiconductor may be used.

A transistor 410 illustrated in FIG. 10A is one of bottom-gate thin film transistors, and is also referred to as an inverted-staggered thin film transistor.

The transistor 410 includes, over a substrate 400 having an insulating surface, the gate electrode layer 401, the gate insulating layer 402, an oxide semiconductor layer. 403, a source electrode layer 405a, and a drain electrode layer 405b. In addition, an insulating layer 407 which covers the transistor 410 and is stacked over the oxide semiconductor layer 403 is provided. A protective insulating layer 409 is provided over the insulating layer 407.

A transistor 420 illustrated in FIG. 10B is one of bottom-gate thin film transistors referred to as a channel-protective type (channel-stop type) and is also referred to as an inverted-staggered thin film transistors.

The transistor 420 includes, over the substrate 400 having an insulating surface, the gate electrode layer 401, the gate insulating layer 402, the oxide semiconductor layer 403, an insulating layer 427 functioning as a channel protective layer which covers a channel formation region of the oxide semiconductor layer 403, the source electrode layer 405a, and the drain electrode layer 405b. A protective insulating layer 409 is formed so as to cover the transistor 420.

A transistor 430 illustrated in FIG. 10C is a bottom-gate thin film transistor and includes, over the substrate 400 having an insulating surface, the gate electrode layer 401, the gate insulating layer 402, the source electrode layer 405a, the drain electrode layer 405b, and the oxide semiconductor layer 403. The insulating layer 407 which covers the transistor 430 and is in contact with the oxide semiconductor layer 403 is provided. The protective insulating layer 409 is provided over the insulating layer 407.

In the transistor 430, the gate insulating layer 402 is provided on and in contact with the substrate 400 and the gate electrode layer 401, and the source electrode layer 405a and the drain electrode layer 405b are provided on and in contact with the gate insulating layer 402. Further, the oxide semiconductor layer 403 is provided over the gate insulating layer 402, the source electrode layer 405a, and the drain electrode layer 405b.

A transistor 440 illustrated in FIG. 10D is one of top-gate thin film transistors. The transistor 440 includes, over the substrate 400 having an insulating surface, an insulating layer 437, the oxide semiconductor layer 403, the source electrode layer 405a, the drain electrode layer 405b, the gate insulating layer 402, and the gate electrode layer 401. A wiring layer 436a and a wiring layer 436b are provided to be in contact with and electrically connected to the source electrode layer 405a and the drain electrode layer 405b, respectively.

In this embodiment, as described above, the oxide semiconductor layer 403 is used as a semiconductor layer. As an oxide semiconductor used for the oxide semiconductor layer 403, an In—Sn—Ga—Zn—O-based oxide semiconductor layer which is an oxide of four metal elements; an In—Ga—Zn—O-based oxide semiconductor layer, an In—Sn—Zn—O-based oxide semiconductor layer, an In—Al—Zn—O-based oxide semiconductor layer, a Sn—Ga—Zn—O-based oxide semiconductor layer, an Al—Ga—Zn—O-based oxide semiconductor layer, or a Sn—Al—Zn—O-based oxide semiconductor layer which are oxides of three metal elements; an In—Zn—O-based oxide semiconductor layer, a Sn—Zn—O-based oxide semiconductor layer, an Al—Zn—O-based oxide semiconductor layer, a Zn—Mg—O-based oxide semiconductor layer, a Sn—Mg—O-based oxide semiconductor layer, or an In—Mg—O-based oxide semiconductor layer which are oxides of two metal elements; or an In—O-based oxide semiconductor layer, a Sn—O-based oxide semiconductor layer, or a Zn—O-based oxide semiconductor layer which are oxides of one metal element can be used. Further, SiO₂ may be contained in the above oxide semiconductor. Addition of silicon oxide (SiOₓ (x>0)) which hinders crystallization into the oxide semiconductor layer can suppress crystallization of the oxide semiconductor layer at the time when heat treatment is performed after formation of the oxide semiconductor layer in the manufacturing process. The oxide semiconductor layer preferably exists in an amorphous state; however, the oxide semiconductor layer may be partly crystallized. Here, for example, an In—Ga—Zn—O-based oxide semiconductor is an oxide semiconductor including at least In, Ga, and Zn, and there is no particular limitation on the composition ratio thereof. Further, the In—Ga—Zn—O-based oxide semiconductor may contain an element other than In, Ga, and Zn.

For the oxide semiconductor layer 403, an oxide semiconductor represented by the chemical formula, InMO₃(ZnO)ₘ (m>0) can be used. Here, M represents one or more metal elements selected from Ga, Al, Mn, and Co. For example, M can be Ga, Ga and Al, Ga and Mn, Ga and Co, or the like.

In the transistors 410, 420, 430, and 440 each including the oxide semiconductor layer 403, the current value in an off state (an off-state current value) can be reduced. Therefore, electrical signal of image data and the like can be held for a longer period, so that a writing interval can be set long. Accordingly, frequency of refresh operation can be reduced, which leads to an effect of suppressing power consumption.

Further, in the transistors 410, 420, 430, and 440 each including the oxide semiconductor layer 403, relatively high field-effect mobility can be obtained, whereby high-speed operation is possible. Therefore, by using any of the transistors in a pixel portion of a liquid crystal display device, high-quality image can be provided. Since the transistors can be separately formed over one substrate in a circuit portion and a pixel portion, the number of components can be reduced in the liquid crystal display device.

Although there is no particular limitation on a substrate used for the substrate 400 having an insulating surface, a glass substrate of barium borosilicate glass, aluminoborosilicate glass, or the like can be used.

In the bottom-gate transistors 410, 420, and 430, an insulating film serving as a base film may be provided between the substrate and the gate electrode layer. The base film has a function of preventing diffusion of an impurity element from the substrate, and can be formed to have a single-layer or stacked-layer structure using one or more films selected from a silicon nitride film, a silicon oxide film, a silicon nitride oxide film, and a silicon oxynitride film.

The gate electrode layer 401 can be formed to have a single-layer or stacked-layer structure using a metal material such as molybdenum, titanium, chromium, tantalum, tungsten, aluminum, copper, neodymium, or scandium, or an alloy material which contains any of these materials as its main component.

The gate insulating layer 402 can be formed to have a single-layer or stacked-layer structure using any of a silicon oxide layer, a silicon nitride layer, a silicon oxynitride layer, a silicon nitride oxide layer, an aluminum oxide layer, an aluminum nitride layer, an aluminum oxynitride layer, an aluminum nitride oxide layer, and a hafnium oxide layer by a plasma CVD method, a sputtering method, or the like. For example, by a plasma CVD method, a silicon nitride layer (SiN_{y} (y>0)) with a thickness of greater than or equal to 50 nm and less than or equal to 200 nm is formed as a first gate insulating layer, and a silicon oxide layer (SiOₓ (x>0)) with a thickness of greater than or equal to 5 nm and less than or equal to 300 nm is formed as a second gate insulating layer over the first gate insulating layer, so that a gate insulating layer with a total thickness of 200 nm is formed.

A conductive film used for the source electrode layer 405a and the drain electrode layer 405b can be formed using an element selected from Al, Cr, Cu, Ta, Ti, Mo, and W, an alloy film containing any of these elements, an alloy film containing a combination of any of these elements, or the like. Alternatively, a structure may be employed in which a high-melting-point metal layer of Ti, Mo, W, or the like is stacked over one of or both of the upper side and lower side of a metal layer of Al, Cu, or the like. In addition, heat resistance can be improved by using an Al material to which an element (Si, Nd, Sc, or the like) which prevents generation of a hillock or a whisker in an Al film is added.

A material similar to that of the source electrode layer 405a and the drain electrode layer 405b can be used for a conductive film such as the wiring layer 436a and the wiring layer 436b which are connected to the source electrode layer 405a and the drain electrode layer 405b, respectively.

Alternatively, the conductive film to be the source electrode layer 405a and the drain electrode layer 405b (including a wiring layer formed in the same layer as the source electrode layer 405a and the drain electrode layer 405b) may be formed using conductive metal oxide. As conductive metal oxide, indium oxide (In₂O₃), tin oxide (SnO₂), zinc oxide (ZnO), indium oxide-tin oxide alloy (In₂O₃—SnO₂, which is abbreviated to ITO), indium oxide-zinc oxide alloy (In₂O₃—ZnO), or any of these metal oxide materials in which silicon oxide is contained can be used.

As the insulating layers 407, 427, and 437, typically, an inorganic insulating film such as a silicon oxide film, a silicon oxynitride film, an aluminum oxide film, or an aluminum oxynitride film can be used.

As the protective insulating layer 409, an inorganic film such as a silicon nitride film, an aluminum nitride film, a silicon nitride oxide film, or an aluminum nitride oxide film can be used.

In addition, a planarization insulating film can be formed over the protective insulating layer 409 in order to reduce surface unevenness due to the transistor. As the planarization insulating film, an organic material such as polyimide, acrylic, benzocyclobutene can be used. Other than such organic materials, it is also possible to use a low-dielectric constant material (a low-k material) or the like. Note that the 10 planarization insulating film may be formed by stacking a plurality of insulating films formed using these materials.

Thus, in this embodiment, a high-performance liquid crystal display device can be provided by using a transistor including an oxide semiconductor layer.

### Embodiment 5

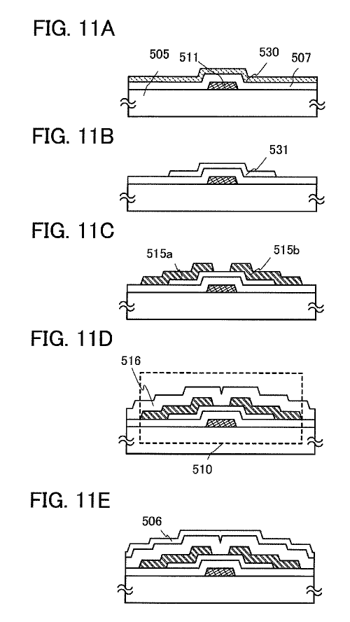

In this embodiment, an example of a transistor including an oxide semiconductor layer and an example of a manufacturing method thereof are described in detail with reference to FIGS. 11A to 11E. The same portions as those in the above embodiments and portions having functions similar to those of the portions in the above embodiments and steps similar to those in the above embodiments may be handled as in the above embodiments, and repeated description is omitted. In addition, detailed description of the same portions is not repeated.

FIGS. 11A to 11E illustrate an example of a cross-sectional structure of a transistor. A transistor 510 illustrated in FIGS. 11A to 11E is a bottom-gate inverted-staggered thin film transistor which is similar to the transistor 410 illustrated in FIG. 10A.

An oxide semiconductor used for a semiconductor layer in this embodiment is an i-type (intrinsic) oxide semiconductor or a substantially i-type (intrinsic) oxide semiconductor. The i-type (intrinsic) oxide semiconductor or substantially i-type (intrinsic) oxide semiconductor is obtained in such a manner that hydrogen, which is an n-type impurity, is removed from an oxide semiconductor, and the oxide semiconductor is highly purified so as to contain as few impurities that are not main components of the oxide semiconductor as possible. In other words, a highly-purified i-type (intrinsic) semiconductor or a semiconductor close thereto is obtained not by adding impurities but by removing impurities such as hydrogen or water as much as possible. Accordingly, the oxide semiconductor layer included in the transistor 510 is an oxide semiconductor layer which is highly purified and made to be electrically i-type (intrinsic).

In addition, a highly-purified oxide semiconductor includes extremely few carriers (close to zero), and the carrier concentration thereof is less than 1×10¹⁴/cm³, preferably less than 1×10¹²/cm³, further preferably less than 1×10¹¹/cm³.

Since the oxide semiconductor includes extremely few carriers, an off-state current can be reduced. The smaller the amount of off-state current is, the better.

Specifically, in the thin film transistor including the oxide semiconductor layer, an off-state current density per micrometer in a channel width at room temperature can be less than or equal to 10 aA/μm (1×10⁻¹⁷ A/μm), further less than or equal to 1 aA/μm (1×10⁻¹⁸ A/μm), or still further less than or equal to 10 zA/μm (1×10⁻²⁰ A/μm).

When a transistor whose current value in an off state (an off-state-current value) is extremely small is used as a transistor in the pixel portion of Embodiment 1, 25 refresh operation in a still image region can be performed with a small number of times of writing image data.

In addition, in the transistor 510 including the oxide semiconductor layer, the temperature dependence of on-state current is hardly observed, and the off-state current remains extremely small.

Steps of manufacturing the transistor 510 over a substrate 505 are described below with reference to FIGS. 11A to 11E.

First, a conductive film is formed over the substrate 505 having an insulating surface, and then, a gate electrode layer 511 is formed through a first photolithography step. Note that a resist mask may be formed by an inkjet method. Formation of the resist mask by an inkjet method needs no photomask; thus, manufacturing cost can be reduced.

As the substrate 505 having an insulating surface, a substrate similar to the substrate 400 described in Embodiment 4 can be used. In this embodiment, a glass substrate is used as the substrate 505.

An insulating film serving as a base film may be provided between the substrate 505 and the gate electrode layer 511. The base film has a function of preventing diffusion of an impurity element from the substrate 505, and can be formed with a single-layer structure or a stacked structure using one or more of a silicon nitride film, a silicon oxide film, a silicon nitride oxide film, and a silicon oxynitride film.

In addition, the gate electrode layer 511 can be formed to have a single-layer or stacked structure using a metal material such as molybdenum, titanium, chromium, tantalum, tungsten, aluminum, copper, neodymium, or scandium, or an alloy material which contains any of these materials as its main component.

Next, a gate insulating layer 507 is formed over the gate electrode layer 511. The gate insulating layer 507 can be formed to have a single-layer structure or a stacked structure using a silicon oxide layer, a silicon nitride layer, a silicon oxynitride layer, a silicon nitride oxide layer, an aluminum oxide layer, an aluminum nitride layer, an aluminum oxynitride layer, an aluminum nitride oxide layer, or a hafnium oxide layer, by a plasma CVD method, a sputtering method, or the like.

As the oxide semiconductor layer in this embodiment, an oxide semiconductor which is made to be an i-type or substantially i-type by removing impurities is used. Such a highly-purified oxide semiconductor is extremely sensitive to an interface level or interface charge; therefore, an interface between the oxide semiconductor layer and the gate insulating layer is important. For that reason, the gate insulating layer that is to be in contact with a highly-purified oxide semiconductor needs to have high quality.

For example, a high-density plasma CVD method using microwaves (e.g., a frequency of 2.45 GHz) is preferably adopted because an insulating layer can be dense and can have high withstand voltage and high quality. When a highly-purified oxide semiconductor and a high-quality gate insulating layer are in close contact with each other, the interface level can be reduced and interface characteristics can be favorable.

It is needless to say that another deposition method such as a sputtering method or a plasma CVD method can be employed as long as a high-quality insulating layer can be formed as a gate insulating layer. Moreover, it is possible to use as the gate insulating layer an insulating layer whose quality and characteristics of an interface with an oxide semiconductor are improved with heat treatment performed after the formation of the insulating layer. In any case, an insulating layer that can reduce interface level density with an oxide semiconductor to form a favorable interface, as well as having favorable film quality as the gate insulating layer, is formed.

Further, in order that hydrogen, a hydroxyl group, and moisture might be contained in the gate insulating layer 507 and an oxide semiconductor film 530 as little as possible, it is preferable that the substrate 505 over which the gate electrode layer 511 is formed or the substrate 505 over which layers up to the gate insulating layer 507 are formed be preheated in a preheating chamber of a sputtering apparatus as pretreatment for deposition of the oxide semiconductor film 530 so that impurities such as hydrogen and moisture adsorbed to the substrate 505 are eliminated and exhaustion is performed. As an exhaustion unit provided in the preheating chamber, a cryopump is preferable. Note that this preheating treatment can be omitted. This preheating step may be similarly performed on the substrate 505 over which components up to and including a source electrode layer 515a and a drain electrode layer 515b are formed before formation of an insulating layer 516.

Next, the oxide semiconductor film 530 having a thickness of greater than or equal to 2 nm and less than or equal to 200 nm, preferably greater thane or equal to 5 nm and less than or equal to 30 nm is formed over the gate insulating layer 507 (see FIG. 11A).

Note that before the oxide semiconductor film 530 is formed by a sputtering method, powder substances (also referred to as particles or dust) which are generated at the time of the deposition and attached on a surface of the gate insulating layer 507 are preferably removed by reverse sputtering in which an argon gas is introduced and plasma is generated. The reverse sputtering refers to a method in which an RF power source is used for application of a voltage to a substrate side in an argon atmosphere to generate plasma in the vicinity of the substrate to modify a surface. Note that instead of an argon atmosphere, a nitrogen atmosphere, a helium atmosphere, an oxygen atmosphere, or the like may be used.

As an oxide semiconductor used for the oxide semiconductor film 530, an oxide semiconductor described in Embodiment 4, such as an oxide of four metal elements, an oxide of three metal elements, an oxide of two metal elements, an In—O-based oxide semiconductor, a Sn—O-based oxide semiconductor, or a Zn—O-based oxide semiconductor can be used. Further, SiO₂ may be contained in the above oxide semiconductor. In this embodiment, the oxide semiconductor film 530 is deposited by sputtering with the use of an In—Ga—Zn—O-based oxide semiconductor target. A cross-sectional view of this stage is shown in FIG. 11A. Alternatively, the oxide semiconductor film 530 can be formed by a sputtering method in a rare gas (typically, argon) atmosphere, an oxygen atmosphere, or a mixed atmosphere of a rare gas and oxygen.

As a target for manufacturing the oxide semiconductor film 530 by a sputtering method, for example, a target having a composition ratio of In₂O₃:Ga₂O₃:ZnO=1:1:1 [molar ratio] can be used. Alternatively, a target having a composition ratio of In₂O₃:Ga₂O₃:ZnO=1:1:2 [molar ratio] or In₂O₃:Ga₂O₃:ZnO=1:1:4 [molar ratio] may be used. The fill rate of the oxide target is higher than or equal to 90% and lower than or equal to 100%, preferably, higher than or equal to 95% and lower than or equal to 99.9%. With use of the metal oxide target with high filling rate, the deposited oxide semiconductor film has high density.

It is preferable that a high-purity gas in which an impurity such as hydrogen, water, a hydroxyl group, or hydride is removed be used as the sputtering gas for the deposition of the oxide semiconductor film 530.

The substrate is placed in a deposition chamber under reduced pressure, and the substrate temperature is set to higher than or equal to 100° C. and lower than or equal to 600° C., preferably higher than or equal to 200° C. and lower than or equal to 400° C. Deposition is performed while the substrate is heated, whereby the concentration of an impurity contained in the oxide semiconductor layer formed can be reduced. In addition, damage by sputtering can be reduced. Then, residual moisture in the deposition chamber is removed, a sputtering gas from which hydrogen and moisture are removed is introduced, and the above-described target is used, so that the oxide semiconductor film 530 is formed over the substrate 505. In order to remove the residual moisture in the deposition chamber, an entrapment vacuum pump, for example, a cryopump, an ion pump, or a titanium sublimation pump is preferably used. The evacuation unit may be a turbo pump provided with a cold trap. In the deposition chamber which is evacuated with the cryopump, for example, a hydrogen atom, a compound containing a hydrogen atom, such as water (H₂O), (further preferably, also a compound containing a carbon atom), and the like are removed, whereby the concentration of an impurity in the oxide semiconductor film formed in the deposition chamber can be reduced.

As one example of the deposition condition, the distance between the substrate and the target is 100 mm, the pressure is 0.6 Pa, the direct-current (DC) power source is 0.5 kW, and the atmosphere is an oxygen atmosphere (the proportion of the oxygen flow rate is 100%). Note that a pulse direct current power source is preferable because powder substances (also referred to as particles or dust) generated in deposition can be reduced and the film thickness can be uniform.

Next, the oxide semiconductor film 530 is processed into an island-shaped oxide semiconductor layer through a second photolithography step. A resist mask for forming the island-shaped oxide semiconductor layer may be formed by an inkjet method. Formation of the resist mask by an inkjet method needs no photomask; thus, manufacturing cost can be reduced.

In the case where a contact hole is formed in the gate insulating layer 507, a step of forming the contact hole can be performed at the same time as processing of the oxide semiconductor film 530.

For the etching of the oxide semiconductor film 530, either one or both of wet etching and dry etching may be employed. As an etchant used for wet etching of the oxide semiconductor film 530, for example, a mixed solution of phosphoric acid, acetic acid, and nitric acid (e.g., ITO07N (produced by Kanto Chemical Co., Inc.)), or the like can be used.

Next, first heat treatment is performed on the oxide semiconductor layer. The oxide semiconductor layer can be dehydrated or dehydrogenated by this first heat treatment. The temperature of the first heat treatment is higher than or equal to 400° C. and lower than or equal to 750° C., or higher than or equal to 400° C. and lower than the strain point of the substrate. Here, the substrate is put in an electric furnace which is a kind of heat treatment apparatus and heat treatment is performed on the oxide semiconductor layer at 450° C. for one hour in a nitrogen atmosphere, and then, water or hydrogen is prevented from entering the oxide semiconductor layer without exposure to the air; thus, an oxide semiconductor layer 531 is obtained (see FIG. 11B).

Note that a heat treatment apparatus is not limited to an electrical furnace, and may include a device for heating an object to be processed by heat conduction or heat radiation from a heating element such as a resistance heating element. For example, a rapid thermal anneal (RTA) apparatus such as a gas rapid thermal anneal (GRTA) apparatus or a lamp rapid thermal anneal (LRTA) apparatus can be used. An LRTA apparatus is an apparatus for heating an object to be processed by radiation of light (an electromagnetic wave) emitted from a lamp such as a halogen lamp, a metal halide lamp, a xenon arc lamp, a carbon arc lamp, a high pressure sodium lamp, or a high pressure mercury lamp. A GRTA apparatus is an apparatus for heat treatment using a high-temperature gas. As the high temperature gas, an inert gas which does not react with an object to be treated by heat treatment, such as nitrogen or a rare gas like argon, is used.

For example, as the first heat treatment, GRTA in which the substrate is moved into an inert gas heated to a high temperature as high as 650° C. to 700° C., heated for several minutes, and moved out of the inert gas heated to the high temperature may be performed.

Note that in the first heat treatment, it is preferable that water, hydrogen, and the like be not contained in the atmosphere of nitrogen or a rare gas such as helium, neon, or argon. It is preferable that the purity of nitrogen or the rare gas such as helium, neon, or argon which is introduced into a heat treatment apparatus be set to be 6N (99.9999%) or higher, preferably 7N (99.99999%) or higher (that is, the impurity concentration is 1 ppm or lower, preferably 0.1 ppm or lower).

Further, after the oxide semiconductor layer is heated in the first heat treatment, a high-purity oxygen gas, a high-purity N₂O gas, or an ultra-dry air (the dew point is lower than or equal to −40° C., preferably lower than or equal to −60° C.) may be introduced into the same furnace. It is preferable that water, hydrogen, and the like be not contained in an oxygen gas or an N₂O gas. The purity of the oxygen gas or the N₂O gas which is introduced into the heat treatment apparatus is preferably 6N or more, more preferably 7N or more (i.e., the concentration of impurities in the oxygen gas or the N₂O gas is preferably 1 ppm or less, more preferably 0.1 ppm or less). By the action of the oxygen gas or the N₂O gas, oxygen which is a main component included in the oxide semiconductor and which has been reduced at the same time as the step for removing impurities by dehydration or dehydrogenation is supplied, so that the oxide semiconductor layer can be a highly-purified and electrically i-type (intrinsic) oxide semiconductor.

In addition, the first heat treatment of the oxide semiconductor layer can also be performed on the oxide semiconductor film 530 which has not yet been processed into the island-shaped oxide semiconductor layer. In that case, the substrate is taken out from the heat apparatus after the first heat treatment, and then a photolithography step is performed.

Note that the first heat treatment may be performed at any of the following timings in addition to the above timing as long as after deposition of the oxide semiconductor layer: after a source electrode layer and a drain electrode layer are formed over the oxide semiconductor layer and after an insulating layer is formed over the source electrode layer and the drain electrode layer.

Further, the step of forming the contact hole in the gate insulating layer 507 may be performed either before or after the first heat treatment is performed on the semiconductor film 530.

In addition, as the oxide semiconductor layer, an oxide semiconductor layer having a crystal region with a large thickness (a single crystal region), that is, a crystal region which is c-axis-aligned perpendicularly to a surface of the film may be formed by performing deposition twice and heat treatment twice, even when any of an oxide, a nitride, a metal, or the like is used for a material of a base component. For example, a first oxide semiconductor film with a thickness greater than or equal to 3 nm and less than or equal to 15 nm is deposited, and first heat treatment is performed in a nitrogen, an oxygen, a rare gas, or a dry air atmosphere at a temperature higher than or equal to 450° C. and lower than or equal to 850° C. or preferably higher than or equal to 550° C. and lower than or equal to 750° C., so that a first oxide semiconductor film having a crystal region (including a plate-like crystal) in a region including a surface is formed. Then, a second oxide semiconductor film which has a larger thickness than the first oxide semiconductor film is formed, and second heat treatment is performed at a temperature higher than or equal to 450° C. and lower than or equal to 850° C. or preferably higher than or equal to 600° C. and lower than or equal to 700° C., so that crystal growth proceeds upward with the use of the first oxide semiconductor film as a seed of the crystal growth and the whole second oxide semiconductor film is crystallized. In such a manner, the oxide semiconductor layer having a crystal region having a large thickness may be formed.

Next, a conductive film serving as the source electrode layer 515a and the drain electrode layer 515b (including a wiring formed in the same layer as the source electrode layer 515a and the drain electrode layer 515b) is formed over the gate insulating layer 507 and the oxide semiconductor layer 531. As the conductive film serving as the source electrode layer 515a and the drain electrode layer 515b, the material used for the source electrode layer 405a and the drain electrode layer 405b which is described in Embodiment 4 can be used.

A resist mask is formed over the conductive film through a third photolithography step, and the source electrode layer 515a and the drain electrode layer 515b are formed by selective etching, and then, the resist mask is removed (see FIG. 11C).

Light exposure at the time of the formation of the resist mask in the third photolithography step may be performed using ultraviolet light, KrF laser light, or ArF laser light. A channel length L of a transistor that is completed later is determined by a distance between bottom end portions of the source electrode layer and the drain electrode layer, which are adjacent to each other over the oxide semiconductor layer 531. In the case where light exposure is performed for a channel length L of less than 25 nm, the light exposure at the time of the formation of the resist mask in the third photolithography step may be performed using extreme ultraviolet having an extremely short wavelength of several nanometers to several tens of nanometers. Light exposure with extreme ultraviolet leads to a high resolution and a large depth of focus. Thus, the channel length L of the transistor that is completed later can be greater than or equal to 10 nm and less than or equal to 1000 nm and the operation speed of a circuit can be increased and furthermore the value of off-state current is extremely small, so that low power consumption can be achieved. In order to reduce the number of photomasks used in a photolithography step and reduce the number of photolithography steps, an etching step may be performed with the use of a multi-tone mask which is a light-exposure mask through which light is transmitted to have various intensities. A resist mask formed with the use of a multi-tone mask has various thicknesses and further can be changed in shape by etching; therefore, the resist mask can be used in a plurality of etching steps for processing into different patterns. Therefore, a resist mask corresponding to at least two kinds or more of different patterns can be formed by one multi-tone mask. Thus, the number of light-exposure masks can be reduced and the number of corresponding photolithography steps can be also reduced, whereby simplification of a process can be realized.

Note that it is preferable that etching conditions be optimized so as not to etch and divide the oxide semiconductor layer 531 when the conductive film is etched. However, it is difficult to obtain etching conditions in which only the conductive film is etched and the oxide semiconductor layer 531 is not etched at all. In some cases, only part of the oxide semiconductor layer 531 is etched when the conductive film is etched, whereby the oxide semiconductor layer 531 having a groove portion (a recessed portion) is formed.

In this embodiment, since the Ti film is used as the conductive film and the In—Ga—Zn—O-based oxide semiconductor is used as the oxide semiconductor layer 531, ammonia hydrogen peroxide (a mixed solution of ammonia, water, and hydrogen peroxide) is used as an etchant for etching the conductive film.

Next, by plasma treatment using a gas such as N₂O, N₂, or Ar, water or the like adsorbed to a surface of an exposed portion of the oxide semiconductor layer may be removed. In the case where the plasma treatment is performed, the insulating layer 516 is formed without exposure to the air as a protective insulating film in contact with part of the oxide semiconductor layer.

The insulating layer 516 can be formed to a thickness of at least 1 nm by a method by which an impurity such as water or hydrogen does not enter the insulating layer 516, such as a sputtering method as appropriate. When hydrogen is contained in the insulating layer 516, entry of the hydrogen to the oxide semiconductor layer, or extraction of oxygen in the oxide semiconductor layer by the hydrogen may occur, thereby causing the backchannel of the oxide semiconductor layer to have lower resistance (to be n-type), so that a parasitic channel may be formed. Therefore, it is important that a deposition method in which hydrogen is not used is employed in order to form the insulating layer 516 containing as little hydrogen as possible.

In this embodiment, a silicon oxide film is formed to a thickness of 200 nm as the insulating layer 516 with a sputtering method. The substrate temperature in deposition may be higher than or equal to room temperature and lower than or equal to 300° C. and in this embodiment, is 100° C. The silicon oxide film can be deposited by a sputtering method in a rare gas (typically, argon) atmosphere, an oxygen atmosphere, or a mixed atmosphere containing a rare gas and oxygen. As a target, a silicon oxide target or a silicon target may be used. For example, the silicon oxide film can be formed using a silicon target by a sputtering method in an atmosphere containing oxygen. As the insulating layer 516 which is formed in contact with the oxide semiconductor layer, an inorganic insulating film which does not include impurities such as moisture, a hydrogen ion, and OH⁻ and blocks entry of these from the outside is used. Typically, a silicon oxide film, a silicon oxynitride film, an aluminum oxide film, an aluminum oxynitride film, or the like is used.

In order to remove residual moisture in the deposition chamber of the insulating layer 516 as in the case of the deposition of the oxide semiconductor film 530, an entrapment vacuum pump (such as a cryopump) is preferably used. When the insulating layer 516 is deposited in the deposition chamber evacuated using a cryopump, the impurity concentration in the insulating layer 516 can be reduced. In addition, as an exhaustion unit for removing the residual moisture in the deposition chamber of the insulating layer 516, a turbo pump provided with a cold trap may be used.

It is preferable that a high-purity gas in which an impurity such as hydrogen, water, a hydroxyl group, or hydride is removed be used as the sputtering gas for the deposition of the insulating layer 516.

Next, second heat treatment is performed in an inert gas atmosphere or oxygen gas atmosphere (preferably at a temperature higher than or equal to 200 and lower than or equal to 400° C., for example, higher than or equal to 250 and lower than or equal to 350° C.). For example, the second heat treatment is performed in a nitrogen atmosphere at 250° C. for one hour. In the second heat treatment, part of the oxide semiconductor layer (a channel formation region) is heated while being in contact with the insulating layer 516.

Through the above process, the first heat treatment is performed on the oxide semiconductor film so that an impurity such as hydrogen, moisture, a hydroxyl group, or hydride (also referred to as a hydrogen compound) is intentionally removed from the oxide semiconductor layer. Additionally, oxygen which is one of main components of an oxide semiconductor and is simultaneously reduced in a step of removing an impurity can be supplied. Accordingly, the oxide semiconductor layer is highly purified to be an electrically i-type (intrinsic) semiconductor.

Through the above process, the transistor 510 is formed (FIG. 11D).

When a silicon oxide layer having a lot of defects is used as the oxide insulating layer, heat treatment after formation of the silicon oxide layer has an effect in diffusing an impurity such as hydrogen, moisture, a hydroxyl group, or hydride contained in the oxide semiconductor layer to the oxide insulating layer so that the impurity contained in the oxide semiconductor layer can be further reduced.

A protective insulating layer 506 may be formed over the insulating layer 516. As the protective insulating layer 506, for example, a silicon nitride film is formed by an RF sputtering method. Since an RF sputtering method has high productivity, it is preferably used as a deposition method of the protective insulating layer. As the protective insulating layer, an inorganic insulating film which does not include an impurity such as moisture and prevents entry of these from the outside, such as a silicon nitride film or an aluminum nitride film is used. In this embodiment, as the protective insulating layer, the protective insulating layer 506 is formed using a silicon nitride film (see FIG. 11E).

In this embodiment, as the protective insulating layer 506, a silicon nitride film is formed by heating the substrate 505 over which layers up to the insulating layer 516 are formed, to a temperature of 100° C. to 400° C., introducing a sputtering gas containing high-purity nitrogen from which hydrogen and moisture are removed, and using a target of silicon semiconductor. In this case, the protective insulating layer 506 is preferably deposited removing moisture remaining in a treatment chamber, similarly to the insulating layer 516.

After the formation of the protective insulating layer 506, heat treatment may be further performed at a temperature of a temperature higher than or equal to 100° C. and lower than or equal to 200° C. in the air for longer than or equal to 1 hour and shorter than or equal to 30 hours. This heat treatment may be performed at a fixed heating temperature. Alternatively, the following change in the heating temperature may be conducted plural times repeatedly: the heating temperature is increased from a room temperature to a temperature higher than or equal to 100° C. and lower than or equal to 200° C. and then decreased to a room temperature.

In this manner, with the use of the transistor including a highly-purified oxide semiconductor layer manufactured using this embodiment, the value of current in an off state (an off-state current value) can be further reduced. Accordingly, an electric signal such as image data can be held for a longer period and a writing interval can be set longer. Therefore, the frequency of refresh operation can be reduced, which leads to a higher effect of suppressing power consumption.

In addition, since the transistor described in this embodiment has high field-effect mobility, high-speed operation is possible. Accordingly, by using the transistor in a pixel portion of a liquid crystal display device, color separation can be suppressed and a high-quality image can be provided. In addition, since the transistor can be separately formed in a driver circuit and a pixel portion over one substrate, the number of components of the liquid crystal display device can be reduced.

This embodiment can be implemented combining with any of the other embodiments as appropriate.

### Embodiment 6

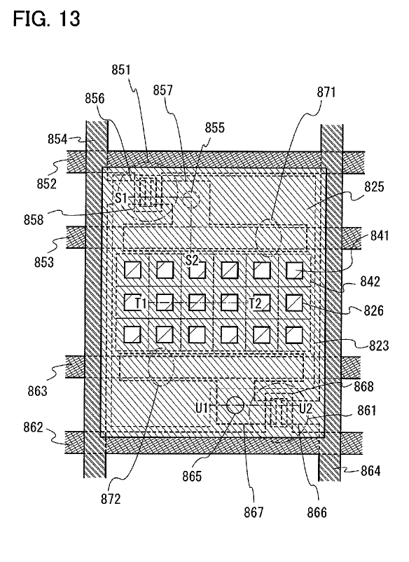

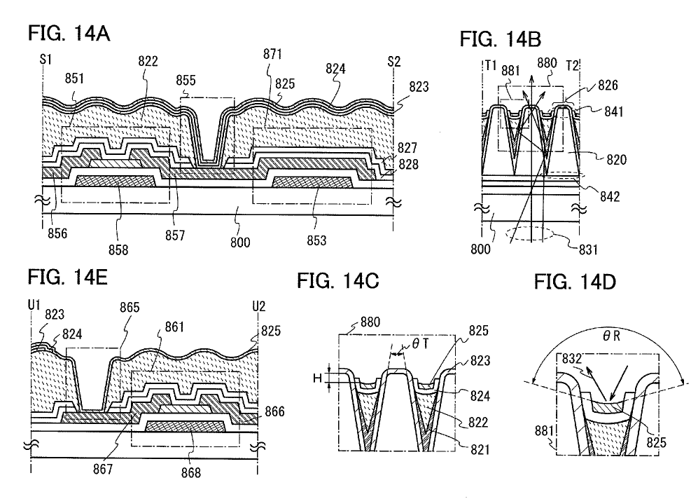

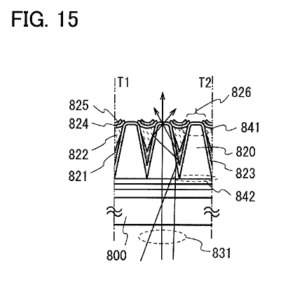

In this embodiment, a pixel structure which enables increase in the amount of reflected light and transmitted light per one pixel in a semi-transmissive liquid crystal display device is described with reference to FIG. 13, FIGS. 14A to 14E, and FIG. 15.

FIG. 13 is a view illustrating a plan structure of a pixel described in this embodiment. FIGS. 14A to 14C illustrate cross-sectional structures of S1-S2 part, T1-T2 part, and U1-U2 part respectively, illustrated by dashed lines in FIG. 13. In a pixel described in this embodiment, a transparent electrode 823 and a reflective electrode 825 are stacked with an insulating layer 824 positioned therebetween over a substrate 800, as a pixel electrode.

The transparent electrode 823 is connected to a drain electrode 857 of a transistor 851 through a contact hole 855 provided in an insulating film 827, an insulating film 828, and an organic resin film 822. The drain electrode 857 is overlapped with a capacitor wiring 853 with an insulating film positioned therebetween to form a storage capacitor 871 (see FIG. 14A).

A gate electrode 858 of the transistor 851 is connected to a wiring 852, and a source electrode 856 thereof is connected to a wiring 854. The transistors described in other embodiments can be used as the transistor 851 (see FIG. 13).

The reflective electrode 825 is connected to a drain electrode 867 of the transistor 851 through a contact hole 865 provided in the insulating film 827, the insulating film 828, and the organic resin film 822 (see FIG. 14A). The drain electrode 867 is overlapped with a capacitor wiring 863 with the insulating film positioned therebetween to form a storage capacitor 872.

A gate electrode 868 of the transistor 861 is connected to a wiring 862, and a source electrode 866 thereof is connected to a wiring 864. The transistors described in other embodiments can be used as the transistor 861 (see FIG. 13).

External light is reflected using the reflective electrode 825, so that the pixel electrode can function as a pixel electrode of a reflective liquid crystal display device. The reflective electrode 825 is provided with a plurality of openings 826 (see FIG. 13). In the opening 826, the reflective electrode 825 does not exist, and the structure 820 and the transparent electrode 823 are projected (see FIG. 14B). Light from the backlight is transmitted through the opening 826, so that the pixel electrode can function as a pixel electrode of a transmissive liquid crystal display device.

In the semi-transmissive liquid crystal display device described in this embodiment, the reflective electrode 825 and the transparent electrode 823 are electrically separated from each other with the insulating layer 824 interposed therebetween. In addition, potentials applied to the transparent electrode 823 and the reflective electrode 825 can be controlled by the transistor 851 and the transistor 861, respectively; therefore, each potential of the reflective electrode 825 and the transparent electrode 823 can be controlled independently. Accordingly, in the case where the semi-transmissive liquid crystal display device is functioned as a transmissive type liquid crystal display device, a liquid crystal display over the reflective electrode can display black.

FIG. 15 is a cross-sectional view illustrating an example different from that in FIG. 14B, which is one embodiment of the present invention having a structure in which the structure 820 and the transparent electrode 823 are not projected in the opening 826. In FIG. 14B, a backlight exit 841 and the opening 826 have almost the same size. On the other hand, in FIG. 15, the backlight exit 841 and the opening 826 have different sizes and different distances from a backlight entrance 842. Accordingly, the amount of transmitted light can be made larger in FIG. 14B than in FIG. 15, and it can be said that the cross-sectional shape in FIG. 14B is preferable.

The structure 820 is formed to be overlapped with the opening 826. FIG. 14B is a cross-sectional view of the portion along T1-T2 in FIG. 13, which illustrates the structures of the pixel electrode and the structure 820. FIG. 14C is an enlarged view of a portion 880, and FIG. 14D is an enlarged view of a portion 881.

A reflected light 832 is external light reflected at the reflective electrode 825. The top surface of the organic resin film 822 is a curving surface with an uneven shape. By reflecting the curving surface with an uneven shape on the reflective electrode 825, the area of the reflective region can be increased, and reflection of an object other than the displayed image is reduced so that visibility of the displayed image can be improved. In the cross-sectional shape, the angle θR at a point where the reflective electrode 825 having a curving surface is most curved, formed by two inclined planes facing each other may be greater than or equal to 90°, preferably greater than or equal to 100° and less than or equal to 120° (see FIG. 14D).

The structure 820 includes the backlight exit 841 on the opening 826 side and the backlight entrance 842 on a backlight (not shown) side. The upper portion of the structure 820 is positioned above the surface of the reflective electrode 825 and protrudes from the upper end portion of the reflective electrode; that is, the distance H between the upper end portion of the structure 820 and the upper end portion of the reflective electrode is greater than or equal to 0.1 μm and less than or equal to 3 μm, preferably greater than or equal to 0.3 μm and less than or equal to 2 μm. The backlight entrance 842 is formed to have a larger area than that of the backlight exit 841. A reflective layer 821 is formed on the side surfaces of the structure 820 (surfaces on which the backlight exit 841 and the backlight entrance 842 are not formed). The structure 820 can be formed using a material having a light-transmitting property such as silicon oxide (SiOx), silicon nitride (SiNx), or silicon oxynitride (SiNO). The reflective layer 821 can be formed using a material with high light reflectance such as aluminum (Al) or silver (Ag).

A transmitted light 831 emitted from the backlight enters the structure 820 through the backlight entrance 842. Some of the incident transmitted light 831 is directly emitted from the backlight exit 841, some are reflected toward the backlight exit 841 by the reflective layer 821, and some are further reflected to return to the backlight entrance 842.

At this time, according to the cross-sectional shape passing through the backlight exit 841 and the backlight entrance 842 of the structure 820, side surfaces on right and left facing each other are inclined surfaces. The angle θT formed by the side surfaces is made to be less than 90°, preferably greater than or equal to 10° and less than or equal to 60°, so that the transmitted light 831 incident from the backlight entrance 842 can be guided efficiently to the backlight exit 841.

In a conventional semi-transmissive liquid crystal display device, when the area of electrode functioning as a reflective electrode is SR and the area of electrode functioning as a transmissive electrode (the area of the opening 826) is ST, the total area of both electrodes is 100% (SR+ST=100%). In the semi-transmissive liquid crystal display device having a pixel structure described in this embodiment, the electrode area ST functioning as a transmissive electrode corresponds to the area of the backlight entrance 842, whereby the amount of transmitted light can be increased without increasing the area of the opening 826 or the luminance of the backlight. In other words, the total area of both electrodes in appearance can be 100% or more (SR+ST is 100% or more).

By using this embodiment, a semi-transmissive liquid crystal display device with bright and high-quality display can be obtained without increasing power consumption.

### Embodiment 7

In this embodiment, an example of an electronic device including the liquid crystal display device described in any of the above embodiments will be described.

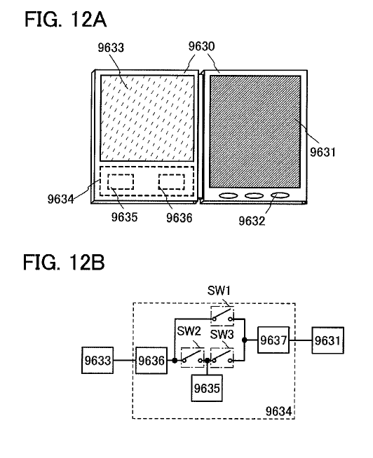

FIG. 12A illustrates an electronic book reader (also referred to as an e-book reader) which can include housings 9630, a display portion 9631, operation keys 9632, a solar battery 9633, and a charge and discharge control circuit 9634. The electronic book reader illustrated in FIG. 12A can have various functions such as a function of displaying various kinds of information (e.g., a still image, a moving image, and a text image); a function of displaying a calendar, a date, a time, and the like on the display portion; a function of operating or editing the information displayed on the display portion; and a function of controlling processing by various kinds of software (programs). Note that in FIG. 12A, a structure including a battery 9635 and a DCDC converter (hereinafter abbreviated as a converter 9636) is illustrated as an example of the charge and discharge control circuit 9634.

With the structure illustrated in FIG. 12A, in the case where a semi-transmissive liquid crystal display device be used as the display portion 9631, use under a relatively bright condition is assumed. Therefore, it is preferable that a semi-transmissive liquid crystal display device be used as the display portion 9631 because power generation by the solar battery 9633 and charge in the battery 9635 are effectively performed. Note that the structure in which the solar battery 9633 is provided on each of a surface and a rear surface of the housing 9630 is preferable to charge the battery 9635 efficiently. When a lithium ion battery is used as the battery 9635, there is an advantage of downsizing or the like.

The structure and the operation of the charge and discharge control circuit 9634 illustrated in FIG. 12A are described with reference to a block diagram in FIG. 12B. The solar battery 9633, the battery 9635, the converter 9636, a converter 9637, switches SW1 to SW3, and the display portion 9631 are shown in FIG. 12B, and the battery 9635, the converter 9636, the converter 9637, and the switches SW1 to SW3 correspond to the charge and discharge control circuit 9634.

First, an example of operation in the case where electric power is generated by the solar battery 9633 using external light is described The voltage of electric power generated by the solar battery is raised or lowered by the converter 9636 so that the power has a voltage for charging the battery 9635. Then, when the electric power from the solar battery 9633 is used for the operation of the display portion 9631, the switch SW1 is turned on and the voltage of the power is raised or lowered by the converter 9637 so as to be a voltage needed for the display portion 9631. In addition, when display on the display portion 9631 is not performed, the switch SW1 is turned off and the switch SW2 is turned on so that charge of the battery 9635 may be performed.

Next, operation in the case where electric power is not generated by the solar battery 9633 using external light is described. The voltage of electric power accumulated in the battery 9635 is raised or lowered by the converter 9637 by turning on the switch SW3. Then, electric power from the battery 9635 is used for the operation of the display portion 9631.

Note that although the solar battery 9633 is described as an example of a means for charge, change of the battery 9635 may be performed with another means. In addition, a combination of the solar battery 9633 and another means for charge may be used.

This embodiment can be implemented in appropriate combination with any of the structures described in the other embodiments.

This application is based on Japanese Patent Application serial No. 2009-298700 filed with Japan Patent Office on Dec. 28, 2009, the entire contents of which are hereby incorporated by reference.

1. A liquid crystal display device comprising:
a display panel including a pixel, the pixel including:
a first sub-pixel including a first pixel electrode which transmits light and a first transistor electrically connected to the first pixel electrode; and
a second sub-pixel including a second pixel electrode which reflects visible light and a second transistor electrically connected to the second pixel electrode,
a backlight portion; and
an image processing circuit including:
a memory circuit configured to store image signals in successive frame periods;
a comparison circuit configured to compare the image signals in the successive frame periods and to detect a difference; and
a display control circuit configured to control the display panel and the backlight portion,
wherein the first transistor is electrically connected to a first signal line,
wherein the second transistor is electrically connected to a second signal line,
wherein the first pixel electrode and the second pixel electrode are each configured to control an orientation state of liquid crystal,
wherein the comparison circuit is configured to determine that the successive frame periods is a moving image period if the difference is detected, so that the display control circuit is configured to output a first signal including a moving image to the first signal line and a second signal to the backlight portion, and
wherein the comparison circuit is configured to determine that the successive frame periods is a still image period if the difference is not detected, so that the display control circuit is configured to output a third signal including a still image to the second signal line.

2. The liquid crystal display device according to claim 1, further comprising a photometric circuit configured to detect a brightness of external light, wherein the display control circuit is capable of outputting the first signal including the moving image to the first signal line in accordance with the brightness of external light even when the comparison circuit determines that the successive frame periods is a still image period.

3. The liquid crystal display device according to claim 1, further comprising a photometric circuit configured to detect a brightness of external light, wherein the display control circuit is capable of outputting the second signal including the still image to the second signal line in accordance with the brightness of external light even when the comparison circuit determines that the successive frame periods is a moving image period.

4. The liquid crystal display device according to claim 1, wherein each of the first transistor and the second transistor includes an oxide semiconductor layer.

5. An electronic device comprising the liquid crystal display device according to claim 1 and a solar battery,
wherein an electric power generated by the solar battery is supplied to at least one of the display panel, the backlight portion, and the image processing circuit.

6. The electronic device according to claim 5, wherein the electronic device is an electronic book reader.

7. The liquid crystal display device according to claim 1, wherein the display control circuit is configured to output a signal for controlling a backlight to the backlight portion if the comparison circuit determines that the successive frame periods is a still image period.

8. The liquid crystal display device according to claim 1, further comprising a mode-switching circuit configured to output a signal for switching between a moving-image mode and a still-image mode to the image processing circuit.

9. A liquid crystal display device comprising:
a plurality of structures over a substrate;
a reflective layer covering side surfaces of the plurality of structures;
an insulating layer covering the reflective layer;
a pixel electrode including:
a reflective electrode provided with a plurality of openings; and
a transparent electrode, portions of the transparent electrode being exposed at the plurality of openings;
a first transistor electrically connected to the transparent electrode; and
a second transistor electrically connected to the reflective electrode,
wherein the plurality of openings and top surfaces of the plurality of structures are overlapped with each other.

10. The liquid crystal display device according to claim 9,
wherein each of the structures has two inclined surfaces facing each other at a cross section as side surfaces,
wherein an angle θT formed by the two inclined surfaces is less than 90°.

11. The liquid crystal display device according to claim 10, wherein the angle θT is greater than or equal to 10° and less than or equal to 60°.

12. The liquid crystal display device according to claim 9,
wherein a portion of the reflective electrode which overlaps with the reflective layer includes a curving surface, and
wherein an angle θR at a point where the portion of the reflective electrode is most curved at a cross section, formed by two inclined planes facing each other is greater than or equal to 90°.

13. The liquid crystal display device according to claim 12, wherein the angle θR is greater than or equal to 100° and less than or equal to 120°.

14. A liquid crystal display device comprising:
a display panel comprising:
a first sub-pixel including a first transistor and a first pixel electrode which transmits light; and
a second sub-pixel including a second transistor and a second pixel electrode which reflects visible light; and
wherein the first pixel electrode and the second pixel electrode are capable of controlling an orientation state of liquid crystal,
wherein a coloring layer is provided to overlap with at least the first pixel electrode,
an image processing circuit configured to determine whether an image signal is a moving image or a still image,
wherein the image signal is output to the first sub-pixel if the image signal is determined to be the moving image, and the image signal is output to the second sub-pixel if the image signal is determined to be the still image.

15. The liquid crystal display device according to claim 14, further comprising a photometric circuit configured to detect a brightness of external light, wherein the image processing circuit is capable of outputting the image signal to the first sub-pixel in accordance with the brightness of external light even when the image processing circuit determines that the image signal is a still image.

16. The liquid crystal display device according to claim 14, further comprising a photometric circuit configured to detect a brightness of external light, wherein the image processing circuit is capable of outputting the image signal to the second sub-pixel in accordance with the brightness of external light even when the image processing circuit determines that the image signal is a moving image.

17. The liquid crystal display device according to claim 14, wherein each of the first transistor and the second transistor includes an oxide semiconductor layer.

18. An electronic device comprising the liquid crystal display device according to claim 14 and a solar battery,
wherein an electric power generated by the solar battery is supplied to at least one of the display panel and the image processing circuit.

19. The electronic device according to claim 18, wherein the electronic device is an electronic book reader.
